(19) United States
(12) Patent Application Publication
(10) Pub. No.: US 2010/0051203 A1
(43) Pub. Date: Mar. 4, 2010

(54) SPECIFICATION-ATTACHING APPARATUS

(75) Inventor: Sheng-Hui Yang, Taichung City (TW)

Correspondence Address: TUROCY & WATSON, LLP, 127 Public Square, 57th Floor, Key Tower, CLEVELAND, OH, 44114, US

(73) Assignee: CVC TECHNOLOGIES, INC., Taichung Hsien (TW)

(21) Appl. No.: 12/204,226

(22) Filed: Sep. 4, 2008

(51) Int. Cl. B65C 9/18

(52) U.S. Cl. 156/542

(57) ABSTRACT

A specification-attaching apparatus includes a transferring mechanism for transferring a specification received in a specification receiving unit into an opening in a platform, wherein the specification is retained in the opening by opposite stop members disposed pivotably and spacedly in the opening. An attaching unit is disposed above the platform, and includes a suction member mounted on a bottom end of a pressing rod, and is operable so as to drive downward movement of the suction member to suck the specification retained in the opening, and so as to drive downward movement of the specification sucked by the suction member to pass through the opening such that the specification sucked by the suction member is attached to a top end of a container conveyed by a container conveying unit, wherein the top end of the container is sprayed with glue by a glue-spraying unit.

### BACKGROUND OF THE INVENTION

1. Field of the Invention

The invention relates to a specification-attaching apparatus, more particularly to a specification-attaching apparatus for attaching a specification to a container.

2. Description of the Related Art

Referring to FIG. 1, a container 100, such as a drug bottle, is generally attached with a label 101. The label 101 is used to classify products, to indicate usage, to display the trademark or logo of the manufacturer, etc. However, an additional specification 102 for indicating other product information is attached manually to the container 100, thereby resulting in relatively high costs.

### SUMMARY OF THE INVENTION

Therefore, an object of the present invention is to provide a specification-attaching apparatus that can automatically attach a specification to a container.

According to the present invention, a specification-attaching apparatus comprises:

a platform having front and rear ends, and top and bottom surfaces, and an opening extending from the top surface to the bottom surface and disposed adjacent to the front end;

a specification receiving unit disposed above the platform and adjacent to the rear end of the platform, and adapted for receiving at least one row of specifications;

a transferring mechanism adapted for transferring one of the specifications received in the specification receiving unit into the opening in the platform;

opposite stop members disposed pivotably in the opening, and spaced apart from each other so as to form a gap therebetween which is smaller than a width of the specifications such that said one of the specifications is retained in the opening in the platform;

a motor-driven container conveying unit disposed under the platform and adjacent to the front end of the platform, having opposite feed-in and take-out ends that flank the platform, and adapted to convey a container from the feed-in end to the take-out end, the container conveying unit being operable so that the container conveyed thereby is aligned with the opening in the platform when said one of the specifications is retained in the opening in the platform;

a glue-spraying unit disposed above the container conveying unit and between the feed-in end of the container conveying unit and the platform, and adapted for spraying glue onto a top end of the container conveyed by the container conveying unit; and

an attaching unit disposed above the platform and including a pressing rod movable vertically relative to the platform, and a suction member mounted on a bottom end of the pressing rod, the attaching unit being operable so as to drive the pressing rod to move downwardly so that said one of the specifications retained in the opening in the platform is sucked by the suction member of the attaching unit, and so as to drive an assembly of the pressing rod, and said one of the specifications sucked by the suction member of the attaching unit to move downwardly such that the stop members rotate in response to pushing by said one of the specifications sucked by the suction member of the attaching unit to move away from each other, thereby permitting the assembly of the pressing rod, and said one of the specifications sucked by the suction member of the attaching unit to pass through the opening in the platform and such that said one of the specifications sucked by the suction member of the attaching unit is attached onto a top end of the container conveyed by the container conveying unit.

Said one of the specifications sucked by the suction member of the attaching unit is adhered to the top end of the container conveyed by the container conveying unit by the glue.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing a container attached with a label and a specification thereon;

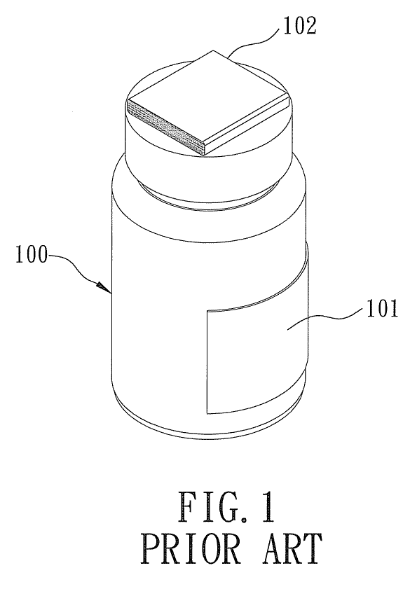

FIG. 2 is a partly schematic sectional view showing the preferred embodiment of a specification-attaching apparatus according to the present invention without a glue-spraying unit;

FIG. 3 is a perspective view showing a platform, a specification receiving unit and a transferring mechanism of the preferred embodiment;

FIG. 4 is a partly schematic sectional view showing the preferred embodiment without the glue-spraying unit when a suction member of the transferring mechanism is at a sucking position;

FIG. 5 is a partly schematic sectional view showing the preferred embodiment without the glue-spraying unit when the suction member of the transferring mechanism is at a releasing position;

FIG. 6 is a perspective view showing a pushing member of the transferring mechanism of the preferred embodiment;

FIG. 7 is a partly schematic sectional view showing the preferred embodiment without the glue-spraying unit when one specification is pushed by a pushing unit of the transferring mechanism into an opening in the platform;

FIG. 8 is a perspective view showing an attaching unit and a positioning unit of the preferred embodiment;

FIG. 9 is a partly schematic sectional view showing the preferred embodiment without the glue-spraying unit when the specification in the opening is sucked by one suction member of the attaching unit; and

FIG. 10 is a schematic front view showing the preferred embodiment without the specification receiving unit and the transferring mechanism when three specifications sucked respectively by three suction members of the attaching unit are attached respectively onto top ends of three containers.

### DETAILED DESCRIPTION OF THE PREFERRED EMBODIMENT

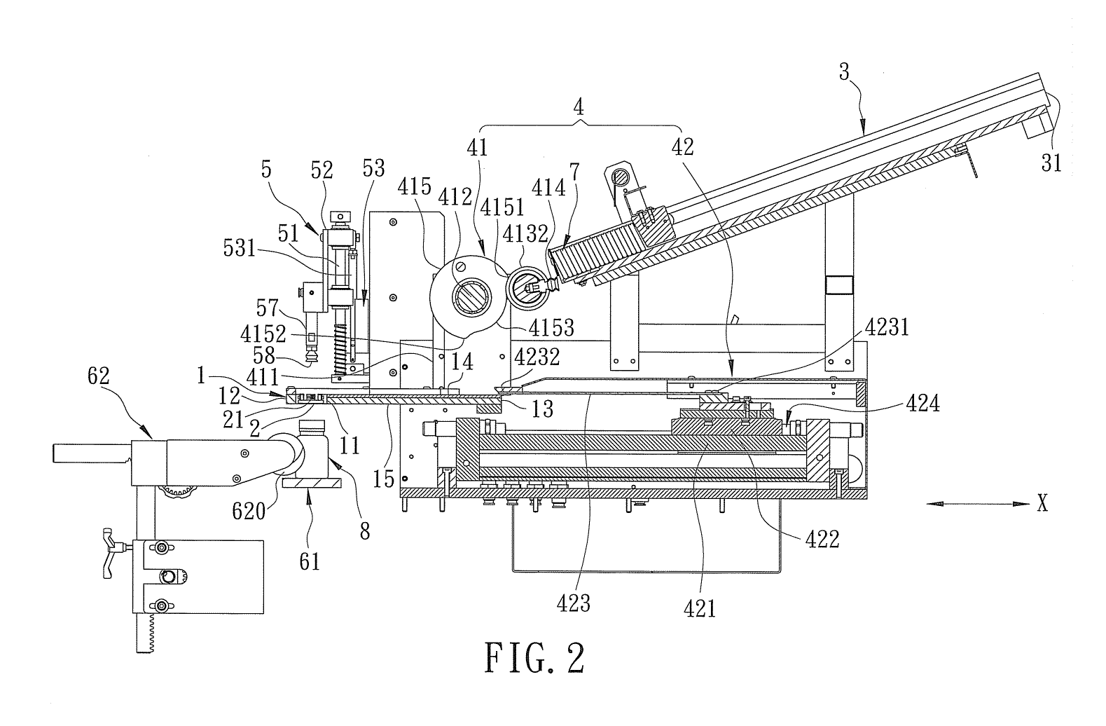

Referring to FIGS. 2, 8 and 10, the preferred embodiment of a specification-attaching apparatus according to the present invention is shown to include a platform 1, a specification receiving unit 3, a transferring mechanism 4, three pairs of stop members 2, a motor-driven container conveying unit 61, a glue-spraying unit 9, and an attaching unit 5.

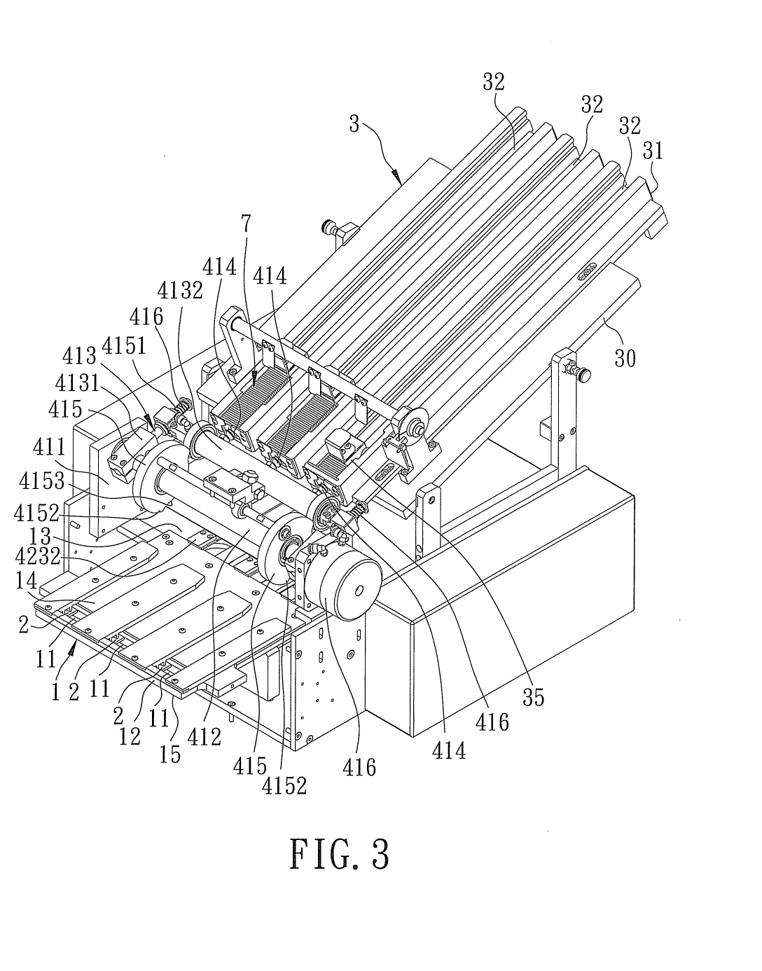

Referring further to FIG. 3, the platform 1 has front and rear ends 12, 13, and top and bottom surfaces 14, 15, and three openings 11 each disposed adjacent to the front end 12 and extending from the top surface 14 to the bottom surface 15.

In this embodiment, as shown in FIG. 3, the specification receiving unit 3 is disposed above the platform 1 and adjacent to the rear end 13 of the platform 1, and includes a groove-defining seat 31 mounted on an inclined plate 30 and configured with three parallel receiving grooves 32 each adapted for receiving a row of specifications 7 therein. The specification receiving unit 3 further includes three loading members 35 mounted on the groove-defining seat 31, disposed movably and respectively in the receiving grooves 32, and adapted to press downwardly the specifications 70 received in the receiving grooves 32.

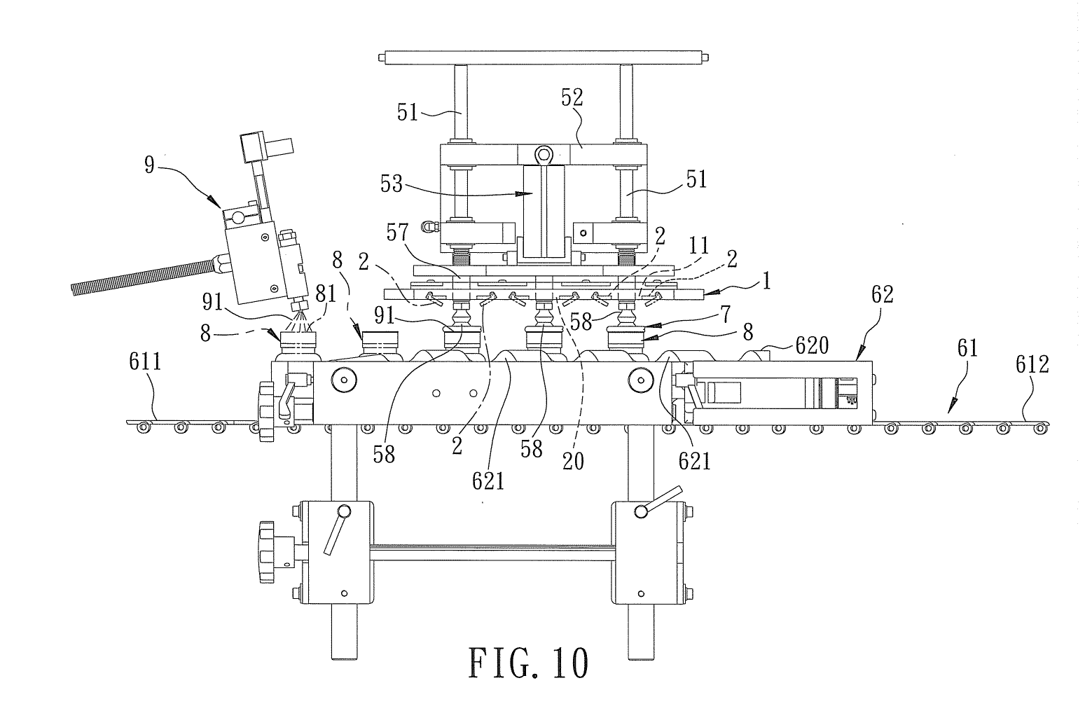

The stop members 2 of each pair are disposed pivotably in a corresponding one of the openings 11 in the platform 1, and are spaced apart from each other so as to form a gap 20 therebetween which is smaller than a width of the specifications 7, as shown in FIG. 10. It is noted that the specification-attaching apparatus further includes three biasing members 21 (see FIG. 2) each biasing a corresponding pair of the stop members 2 to move toward each other. In this embodiment, each biasing member 21 includes two torsion springs.

The transferring mechanism 4 is adapted for transferring one of the specifications 7 received in each receiving groove 32 in the groove-defining seat 31 of the specification receiving unit 3 into a corresponding one of the openings 11 in the platform 1. The transferring mechanism 4 includes 1 transferring unit 41 and a pushing unit 42.

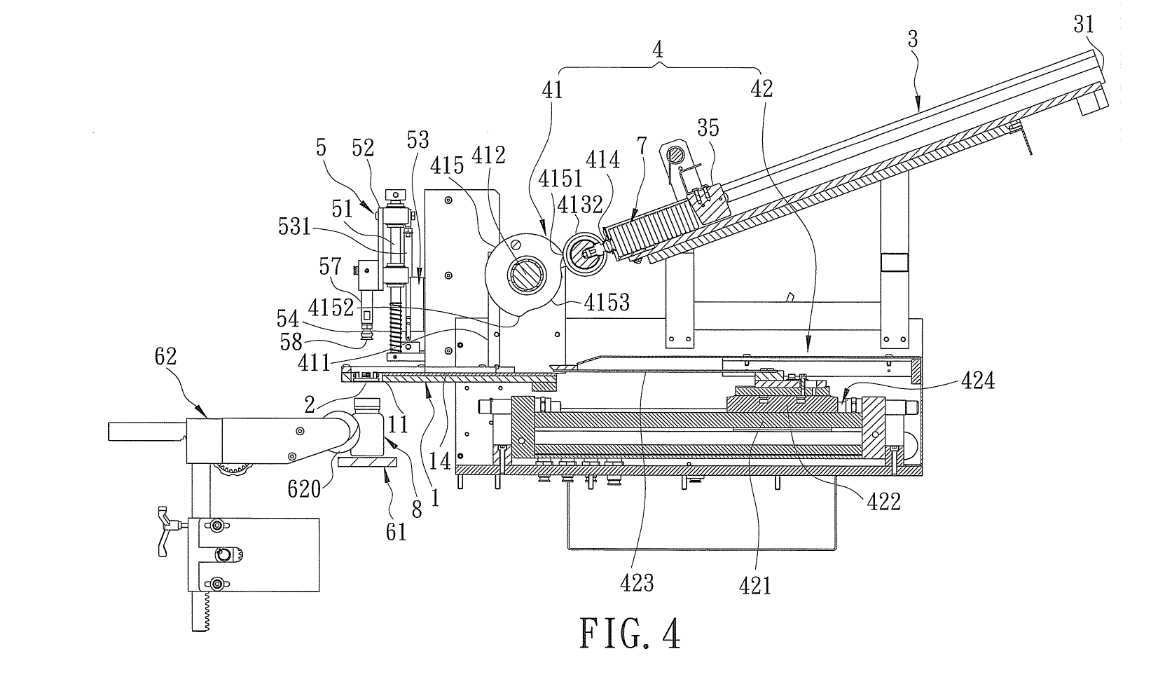

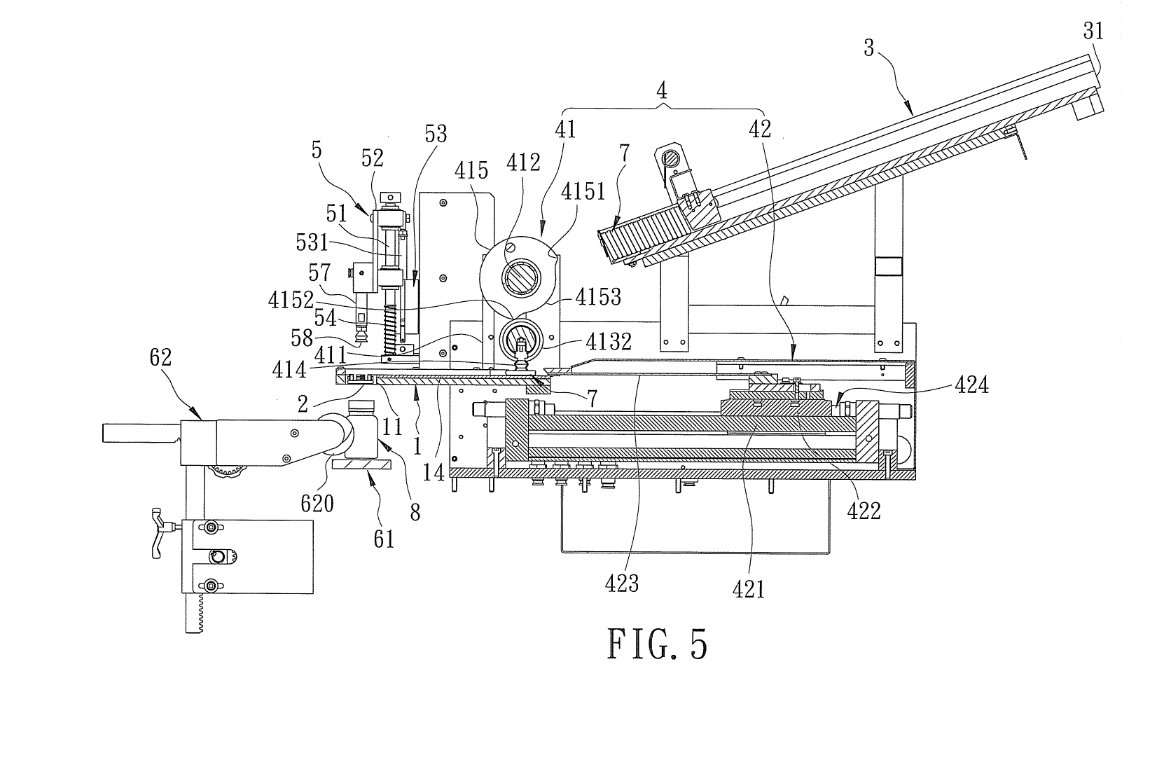

The transferring unit 41 is adapted for transferring said one of the specifications 7 received in each receiving groove 32 to the top surface 14 of the platform 1. In this embodiment, as shown in FIG. 3, the transferring unit 41 includes a mounting frame 411, an axle rod 412, a pivot member 413, three suction members 414, a driving unit 416, two cam bodies 415, and two coil springs 416. The axle rod 412 is mounted fixedly on the mounting frame 411, and is disposed above the platform 1. The pivot frame 413 is connected pivotably to the axle rod 412, and includes two pivot rods 4131 spaced apart from each other and connected pivotably to the axle rod 412, and an intermediate connecting rod 4132 interconnecting slidably the pivot rods 4131. The suction members 414, such as suckers, are mounted on the intermediate connecting rod 4132, and are operable between sucking and non-sucking states. The driving unit 416 is mounted on the mounting frame 411 for driving the pivot member 413 to rotate about the axle rod 412 so that each suction member 414 is movable between an upper sucking position which is adjacent to the specification receiving unit 3, as shown in FIG. 4, and a lower releasing position which is adjacent to the top surface 14 of the platform 1, as shown in FIG. 5. Each suction member 414 is switched from the non-sucking state to the sucking state when at the sucking position, so that said one of the specifications 7 received in a corresponding one of the receiving grooves 32 in the groove-defining seat 31 of the specification receiving unit 3 is sucked thereby. On the other hand, each suction member 414 is switched from the sucking state to the non-sucking state when at the releasing position, so that said one of the specifications 7 is released therefrom and placed on the top surface 14 of the platform 1. The two cam bodies 415 are sleeved spacedly and fixedly on the axle rod 412. Each cam body 415 has first and second projecting edge portions 4151, 4152 spaced apart from each other, and a curved cam surface 4153 disposed between the first and second projecting edge portions 4151, 4152, as shown in FIG. 2. The intermediate connecting rod 4132 of the pivot member 413 is pushed by the first projecting edge portions 4151 of the cam bodies 415 to move toward the specification receiving unit 3 so as to move each suction member 414 to the sucking position, as shown in FIG. 4, and is pushed by the second projecting edge portions 4152 of the cam bodies 415 to move toward the top surface 14 of the platform 1 so as to move each suction member 414 to the releasing position, as shown in FIG. 5. The coil springs 416 are sleeved respectively on the pivot rods 4131 of the pivot member 413 (see FIG. 3) for biasing the intermediate connecting rod 4132 of the pivot member 413 to abut movably against the cam surfaces 4153 of the cam bodies 415 when each suction member 414 is moved between the sucking and releasing positions, as shown in FIG. 2.

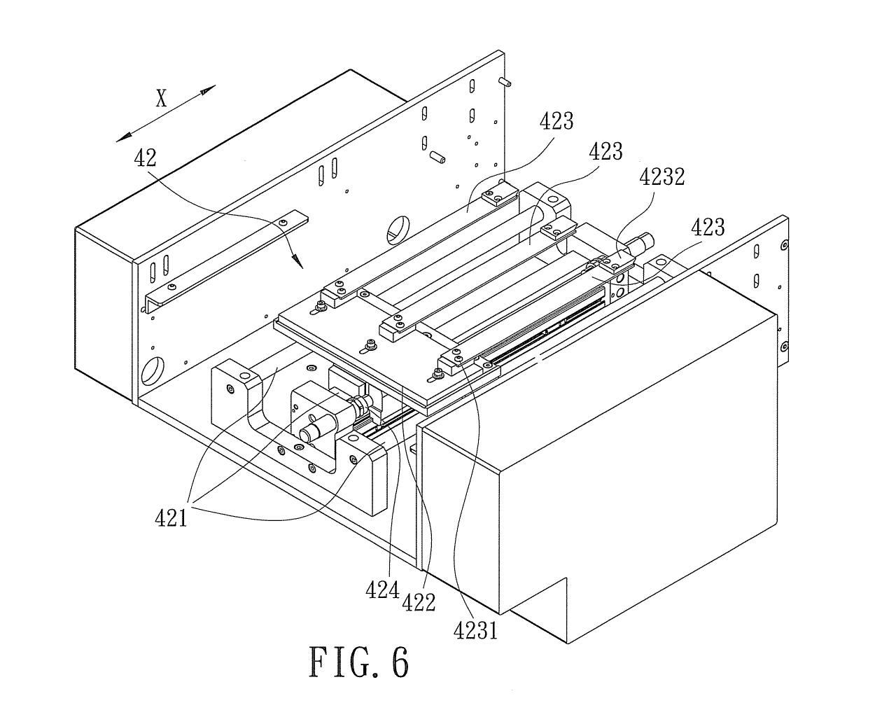

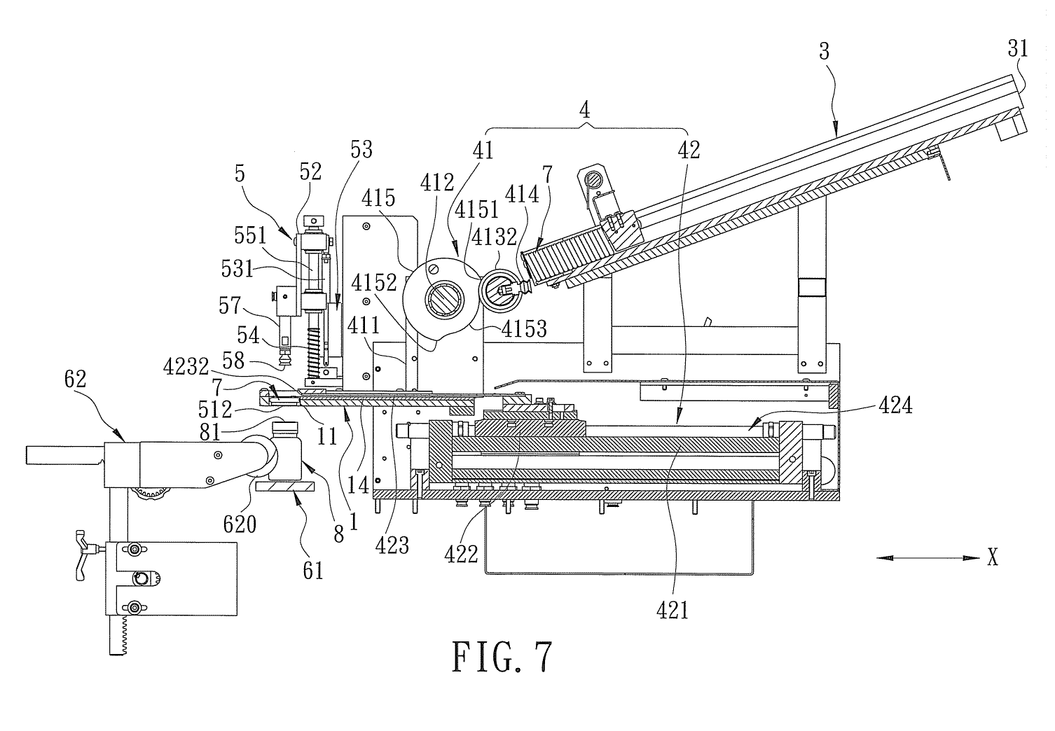

The pushing unit 42 is adapted for pushing frontwardly said ones of the specifications 7, transferred by the transferring unit 41 to the top surface 14 of the platform 1, to move respectively in a horizontal direction (X) and into the openings 11 in the platform 1. In this embodiment, referring further to FIGS. 6 and 7, the pushing unit 42 includes a rail unit 421, a sliding seat 422, three elongate pushing rods 423, and a hydraulic cylinder 424. The rail unit 421 extends in the horizontal direction (X), and is disposed adjacent to the rear end 13 of the platform 1. The sliding seat 422 is mounted slidably on the rail unit 421. Each pushing rod 423 has a connecting end 4231 connected to the sliding seat 422, and a pushing end 4232 opposite to the connecting end 4231 in the horizontal direction (X). The hydraulic cylinder 424 drives the sliding seat 422 to move between a first position, where the pushing end 4232 of each pushing rod 423 is disposed on the top surface 14 of the platform 1 and adjacent to the rear end 14 of the platform 1, as shown in FIG. 2, and a second position, where the pushing end 4232 of each pushing rod 423 is disposed adjacent to a corresponding one of the openings 11 in the platform 1, as shown in FIG. 7. Said ones of the specifications 7, transferred by the transferring unit 41 to the top surface 14 of the platform 1, are pushed by the pushing ends 4232 of the pushing rods 423 to move into the openings 11 in the platform 1, respectively, when the sliding seat 422 is driven by the hydraulic cylinder 242 to move from the first position to the second position. It is noted that, due to the presence of the stop members 2, said ones of the specifications 7 are respectively retained in the openings 11 in the platform 1.

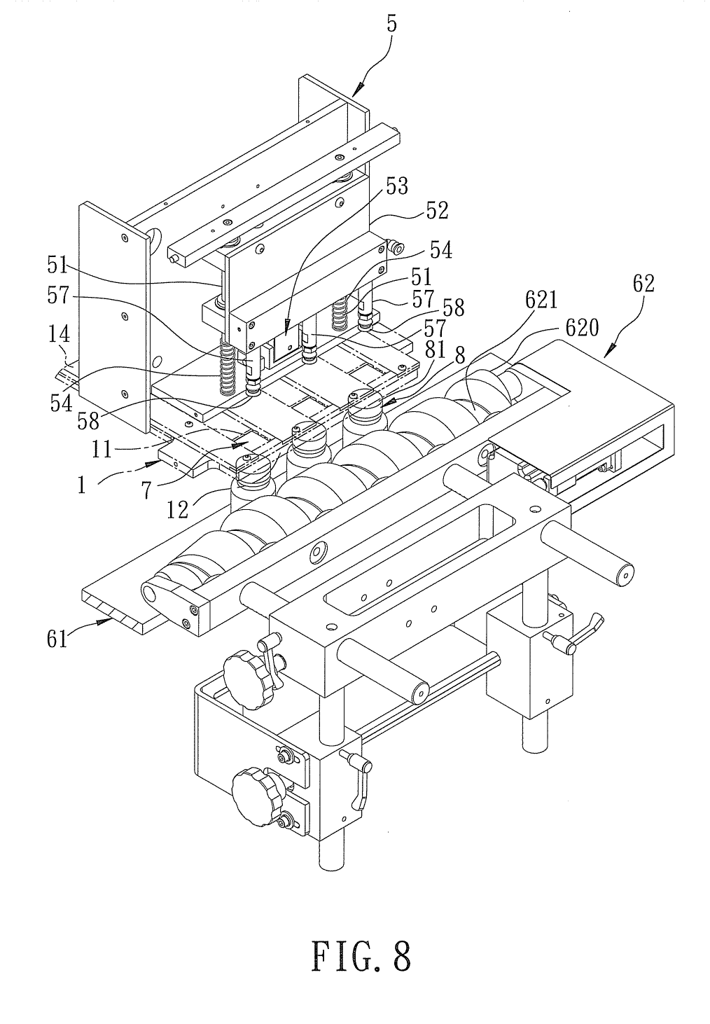

As shown in FIG. 10, the container conveying unit 61 is disposed under the platform 1 and adjacent to the front end 12 of the platform 1, has feed-in and take-out ends 611, 612 that flank the platform 1, and is adapted to convey a plurality of containers 8 from the feed-in end 611 to the take-out end 612. The container conveying unit 61 is operable so that the containers 8 conveyed thereby are respectively aligned with the openings 11 in the platform 1 when said ones of the specifications 7 are respectively retained in the openings 11 in the platform 1, as shown in FIG. 8.

As shown in FIG. 10, the glue-spraying unit 9 is disposed above the container conveying unit 61 and between the feed-in end 611 of the container conveying unit 61 and the platform 1, and is adapted for spraying glue 91 onto a top end 81 of each container 8 conveyed by the container conveying unit 61.

Referring further to FIGS. 7 to 10, the attaching unit 5 is disposed above the platform 1. In this embodiment, the attaching 5 includes a guide rod unit, a sliding seat 52, a hydraulic cylinder 53, three pressing rods 57, and three suction members 58. The guide rod unit includes two guide rods 51 in this embodiment, and is disposed uprightly above the top surface 14 of the platform 1. The sliding seat 52 is sleeved slidably on the guide rods 51 of the guide rod unit. The pressing rods 57 are mounted spacedly on a bottom side of the sliding seat 52. The hydraulic cylinder 53 has a movable piston rod 531 connected to the sliding seat 52, and drives the sliding seat 52 to move downwardly toward the platform 1. The suction members 58, such as suckers, are mounted on bottom ends of the pressing rods 57, respectively.

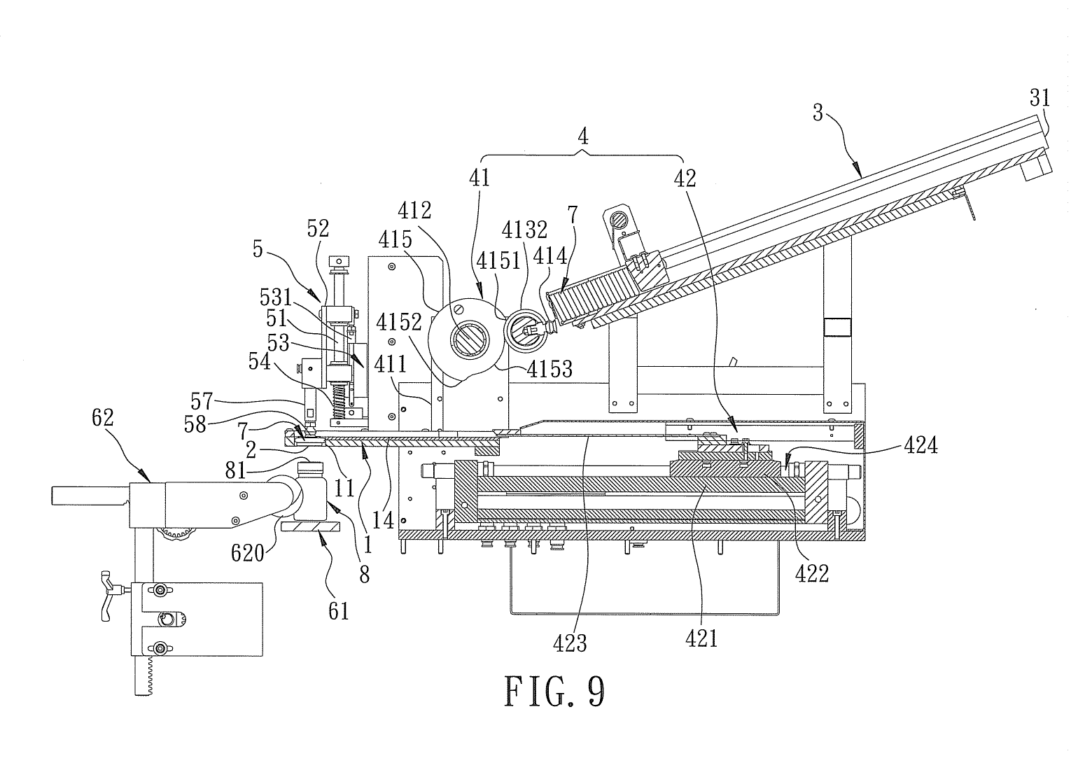

In operation, the attaching unit 5 is operable so as to drive the pressing rods 57 to move downwardly so that said ones of the specifications 7, retained respectively in the openings 11 in the platform 1, are respectively sucked by the suction members 58, as shown in FIG. 9, and so as to drive an assembly of the pressing rods 57, and said ones of the specifications 7 sucked respectively by the suction members 58 to move downwardly such that the stop members 2 in each opening 11 rotate in response to pushing by a corresponding one of said ones of the specifications 7 sucked by the suction members 58 to move away from each other, thereby permitting the assembly of the pressing rods 57, and said ones of the specifications 7 sucked respectively by the suction members 58 to pass through the opening 11 in the platform 1 and such that said ones of the specifications 7 sucked respectively by the suction members 58 are respectively attached onto top ends 81 of the containers 8 conveyed by the container conveying unit 61, as shown in FIG. 10. As a result, said ones of the specifications 7 sucked respectively by the suction members 58 are respectively adhered to the top ends 81 of the containers 8 conveyed by the container conveying unit 61 by the glue 91. As such, the containers 8 attached with said ones of the specifications 7 can be obtained at the take-out end 612 of the container conveying unit 61. Furthermore, the attaching unit 5 further includes a biasing member for biasing the sliding seat 52 to move upwardly away from the platform 1. In this embodiment, the biasing member includes two coil springs 54 sleeved respectively on the guide rods 51 of the guide rod unit, as best shown in FIG. 8.

The specification-attaching apparatus further includes a positioning unit 62 adapted for positioning the containers 8 conveyed by the container conveying unit 61 when said ones of the specifications 7 are respectively attached onto the top ends 81 of the containers 8 conveyed by the container conveying unit 61. In this embodiment, as shown in FIG. 8, the positioning unit 62 includes a screw rod 620 disposed pivotably adjacent to the front end 12 of the platform 1, and having a helical groove 621 that is adapted to engage movably the containers 8 conveyed by the container conveying unit 61.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A specification-attaching apparatus comprising:
a platform having front and rear ends, and top and bottom surfaces, and an opening extending from said top surface to said bottom surface and disposed adjacent to said front end;
a specification receiving unit disposed above said platform and adjacent to said rear end of said platform, and adapted for receiving at least one row of specifications;
a transferring mechanism adapted for transferring one of the specifications received in said specification receiving unit into said opening in said platform;
opposite stop members disposed pivotably in said opening, and spaced apart from each other so as to form a gap therebetween which is smaller than a width of the specifications such that said one of the specifications is retained in said opening in said platform;
a motor-driven container conveying unit disposed under said platform and adjacent to said front end of said platform, having opposite feed-in and take-out ends that flank said platform, and adapted to convey a container from said feed-in end to said take-out end, said container conveying unit being operable so that the container conveyed thereby is aligned with said opening in said platform when said one of the specifications is retained in said opening in said platform;
a glue-spraying unit disposed above said container conveying unit and between said feed-in end of said container conveying unit and said platform, and adapted for spraying glue onto a top end of the container conveyed by said container conveying unit; and
an attaching unit disposed above said platform and including a pressing rod movable vertically relative to said platform, and a suction member mounted on a bottom end of said pressing rod, said attaching unit being operable so as to drive said pressing rod to move downwardly so that said one of the specifications retained in said opening in said platform is sucked by said suction member of said attaching unit, and so as to drive an assembly of said pressing rod, and said one of the specifications sucked by said suction member of said attaching unit to move downwardly such that said stop members rotate in response to pushing by said one of the specifications sucked by said suction member of said attaching unit to move away from each other, thereby permitting the assembly of said pressing rod, and said one of the specifications sucked by said suction member of said attaching unit to pass through said opening in said platform and such that said one of the specifications sucked by said suction member of said attaching unit is attached onto a top end of the container conveyed by said container conveying unit;
wherein said one of the specifications sucked by said suction member of said attaching unit is adhered to the top end of the container conveyed by said container conveying unit by the glue.

2. The specification-attaching apparatus as claimed in claim 1, further comprising a biasing member for biasing said stop members to move toward each other.

3. The specification-attaching apparatus as claimed in claim 1, wherein said transferring mechanism includes:
a transferring unit adapted for transferring said one of the specifications received in said specification receiving unit to said top surface of said platform; and
a pushing unit adapted for pushing frontwardly said one of the specifications, transferred by said transferring unit to said top surface of said platform, to move in a horizontal direction and into said opening in said platform.

4. The specification-attaching apparatus as claimed in claim 3, wherein:
said pushing unit of said transferring mechanism includes
a rail unit extending in the horizontal direction and disposed adjacent to said rear end of said platform,
a sliding seat mounted slidably on said rail unit,
an elongate pushing rod having a connecting end connected to said sliding seat, and a pushing end opposite to said connecting end in the horizontal direction, and
a hydraulic cylinder for driving said sliding seat to move between a first position, where said pushing end of said pushing rod is disposed on said top surface of said platform and adjacent to said rear end of said platform, and a second position, where said pushing end of said pushing rod is disposed adjacent to said opening in said platform; and
said one of the specifications, transferred by said transferring unit to said top surface of said platform, is pushed by said pushing end of said pushing rod to move into said opening in said platform when said sliding seat is driven by said hydraulic cylinder to move from the first position to the second position.

5. The specification-attaching apparatus as claimed in claim 3, wherein:
said transferring unit of said transferring mechanism includes:
an axle rod disposed above said platform,
a pivot member connected pivotably to said axle rod,
a suction member mounted on said pivot member and operable between sucking and non-sucking states, and
a driving unit for driving said pivot member to rotate about said axle rod so that said suction member of said transferring unit is movable between an upper sucking position which is adjacent to said specification receiving unit, and a lower releasing position which is adjacent to said top surface of said platform; and
said suction member of said transferring unit is switched from the non-sucking state to the sucking state when said suction member of said transferring unit is at the sucking position so that said one of the specifications received in the specification receiving unit is sucked thereby, and is switched from the sucking state to the non-sucking state when said suction member of said transferring unit is at the releasing position so that said one of the specifications is released therefrom and placed on said top surface of said platform.

6. The specification-attaching apparatus as claimed in claim 5, wherein:
said pivot member of said transferring unit includes two pivot rods spaced apart from each other and connected pivotably to said axle rod, and an intermediate connecting rod interconnecting slidably said pivot rods and mounted with said suction member of said transferring unit thereon; and
said transferring unit further includes
two cam bodies sleeved spacedly and fixedly on said axle rod, each of said cam bodies having first and second projecting edge portions spaced apart from each other, and a curved cam surface disposed between said first and second projecting edge portions, said intermediate connecting rod of said pivot member being pushed by said first projecting edge portions of said cam bodies to move toward said specification receiving unit so as to move said suction member of said transferring unit to the sucking position, and being pushed by said second projecting edge portions of said cam bodies to move toward said top surface of said platform so as to move said suction member of said transferring unit to the releasing position, and
two coil springs sleeved respectively on said pivot rods for biasing said intermediate connecting rod to abut movably against said cam surfaces of said cam bodies when said suction member of said transferring unit is moved between the sucking and releasing positions.

7. The specification-attaching apparatus as claimed in claim 1, wherein said attaching unit further includes:
a guide rod unit disposed uprightly above said top surface of said platform;
a sliding seat sleeved slidably on said guide rod unit and mounted with said pressing rod on a bottom side thereof; and
a hydraulic cylinder for driving said sliding seat to move downwardly toward said platform such that said pressing rod is moved downwardly toward the container conveyed by said container conveying unit through said opening in said platform.

8. The specification-attaching apparatus as claimed in claim 7, wherein said attaching unit further includes a biasing member for biasing said sliding seat to move upwardly away from said platform.

9. The specification-attaching apparatus as claimed in claim 1, further comprising a positioning unit adapted for positioning the container conveyed by said container conveying unit when said one of the specifications sucked by said suction member of said attaching unit is attached onto the top end of the container conveyed by said container conveying unit.

10. The specification-attaching apparatus as claimed in claim 9, wherein said positioning unit includes a screw rod disposed pivotably adjacent to said front end of said platform and having a helical groove that is adapted to engage movably the container conveyed by said container conveying unit.
